(19) United States
(12) Patent Application Publication
(10) Pub. No.: US 2016/0023490 A1
(43) Pub. Date: Jan. 28, 2016

(54) RECORDING APPARATUS

(71) Applicant: SEIKO EPSON CORPORATION, Tokyo (JP)

(72) Inventor: Masahiko SATO, Matsumoto (JP)

(21) Appl. No.: 14/804,645

(22) Filed: Jul. 21, 2015

(30) Foreign Application Priority Data
Jul. 28, 2014 (JP) 2014-152637

(51) Int. Cl. B41J 29/12; B41J 2/155

(52) U.S. Cl. CPC B41J 29/12; B41J 2/155

(57) ABSTRACT

A recording apparatus includes a transporting portion for intermittently transporting a recording medium, a recording head which is opposed to a transporting route of the recording medium transported by the transporting portion and in which recording is performed on the recording medium in a state separated from the recording medium, and a head guard which is provided separated from the recording medium on the recording head side of the transporting route and includes a first part positioned on an upper stream side than the recording head in a transporting direction of the recording medium transported by the transporting portion, in which a length of the first part in the transporting direction is equal to a transportation distance of the recording medium intermittently transported by the transporting portion or is longer than the transportation distance.

### BACKGROUND

1. Technical Field

The present invention relates to a recording apparatus or the like.

2. Related Art

An ink jet recording apparatus is known as an example of a recording apparatus. In the ink jet recording apparatus, recording is performed on a recording medium by discharging ink from a recording head on a recording medium such as a recording paper. Generally, in the ink jet recording apparatus, recording is performed on the recording medium by discharging ink from the recording head toward the recording paper while changing a relative position of the recording head with respect to the recording medium. As such an ink jet recording apparatus, an ink jet recording apparatus in which an adhesive member is disposed to a holder holding the recording head is known in the related art (for example, refer to JP-A-6-15818).

In the ink jet recording apparatus described in JP-A-6-15818, the adhesive member is positioned on an upstream side of the recording head in a transporting direction of the recording medium and is close to and is opposed to the recording medium. Accordingly, it is possible to remove fluff or the like on the recording medium immediately before recording is performed by displacing the recording head in a main scanning direction. However, the length of the adhesive member in the transporting direction has not been proposed in JP-A-6-15818. Therefore, there is room for further improvement in the recording apparatus in the related art.

### SUMMARY

The invention can be realized in the following forms or application examples.

### Application Example 1

According to this application example, there is provided a recording apparatus including a transporting portion for intermittently transporting a recording medium, a recording head which is opposed to a transporting route of the recording medium transported by the transporting portion and in which recording is performed on the recording medium in a state separated from the recording medium, and a fluff collecting portion which is provided separated from the recording medium on the recording head side of the transporting route and includes a first part positioned on an upper stream side than the recording head in a transporting direction of the recording medium transported by the transporting portion, in which a length of the first part in the transporting direction is equal to a transportation distance of the recording medium intermittently transported by the transporting portion or is longer than the transportation distance.

In the recording apparatus in this application example, it is possible to keep the transportation distance of the recording medium intermittently transported by the transporting portion within a range facing the fluff collecting portion while the transportation of the recording medium stops. When the transportation distance is within a range facing the fluff collecting portion while the transportation of the recording medium stops, it is easy to sufficiently obtain a removal effect of fluff or the like by the fluff collecting portion. Therefore, it is preferable that the length of the first part positioned on the upper stream side than the recording head in the fluff collecting portion, in the transporting direction is equal to the transportation distance of the recording medium intermittently transported or is longer than the transportation distance.

### Application Example 2

In the recording apparatus, a length in the transporting direction of the first part is equal to a recordable length along the transporting direction in the recording head or is longer than the recordable length.

In this application example, it is possible to keep the recordable length along the transporting direction in the recording head within a range facing the fluff collecting portion while the transportation of the recording medium stops. When the recordable length is within a range facing the fluff collecting portion while the transportation of the recording medium stops, it is easy to sufficiently obtain a removal effect of fluff or the like by the fluff collecting portion. Therefore, it is preferable that the length of the first part positioned on the upper stream side than the recording head in the fluff collecting portion, in the transporting direction is equal to the recordable length along the transporting direction in the recording head or is longer than the recordable length.

### Application Example 3

In the recording apparatus, the recording apparatus has a carriage for holding the recording head and a carriage transporting portion for reciprocatably transporting the carriage along an intersecting direction which is a direction intersecting with the transporting direction, in which the fluff collecting portion is provided in the carriage, a plurality of nozzles capable of ejecting ink are formed in a region facing the transporting route in the recording head, the plurality of nozzles configure a nozzle row which is arrayed in a direction intersecting with the intersecting direction, and the recordable length is a length of the nozzle row along the transporting direction.

In this application example, since the fluff collecting portion is provided in the carriage, it is possible to remove fluff or the like adhered to the recording medium on the upstream side of the recording head by moving the carriage in the intersecting direction. In addition, in this recording apparatus, it is possible to keep the length of the nozzle row which is the recordable length along the transporting direction is within a range facing the fluff collecting portion while the transportation of the recording medium stops. When the length of the nozzle row along the transporting direction is within a range facing the fluff collecting portion while the transportation of the recording medium stops, it is easy to sufficiently obtain a removal effect of fluff or the like by the fluff collecting portion. Therefore, it is preferable that the length of the first part positioned on the upper stream side than the recording head in the fluff collecting portion, in the transporting direction is equal to the length of the nozzle row along the transporting direction or is longer than the length of the nozzle row along the transporting direction.

### Application Example 4

In the recording apparatus, the fluff collecting portion is provided on the intersecting direction side of the carriage and extends over a region overlapping with the recording head from an upper stream side in the transporting direction than the recording head when being viewed from the intersecting direction.

In this application example, it is possible to remove fluff or the like adhered to the recording medium not only on the upper stream side in the transporting direction than the recording head but also in the region overlapping with the recording head when being viewed from the intersecting direction.

### Application Example 5

In the recording apparatus, a gap amount between the fluff collecting portion and the recording medium is narrower than a gap amount between the recording head and the recording medium.

In this application example, since it is possible to remove fluff or the like in excess of the gap amount between the fluff collecting portion and the recording medium by the fluff collecting portion, it is easy to avoid a case where fluff or the like comes into contact with the recording head.

### BRIEF DESCRIPTION OF THE DRAWINGS

The invention will be described with reference to the accompanying drawings, wherein like numbers reference like elements.

FIG. 1 is a perspective view illustrating a main configuration of a printer in Embodiment 1.

FIG. 2 is a bottom view illustrating a recording head in Embodiment 1.

FIG. 3 is a plane view illustrating a carriage in Embodiment 1.

FIG. 4 is a side view illustrating the carriage in Embodiment 1.

FIG. 5 is a plane view illustrating the carriage in Embodiment 1.

FIG. 6 is a plane view illustrating a carriage in Embodiment 2.

FIG. 7 is a plane view illustrating a carriage in Embodiment 3.

### DESCRIPTION OF EXEMPLARY EMBODIMENTS

Embodiments will be described by giving a printer which is one of recording apparatuses as an example with reference to drawings. Meanwhile, in each drawing, in order to set each configuration to a size to some extent capable of being recognized, the reduction scales of configurations or members are sometimes different.

### Embodiment 1

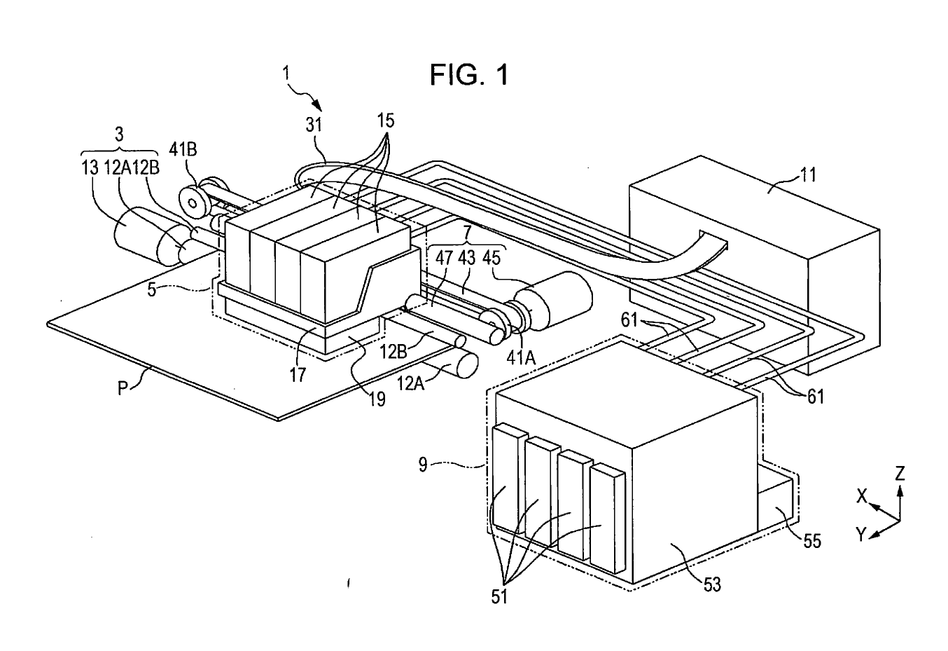

A printer 1 in the embodiment has a transporting device 3, a recording portion 5, a moving device 7, an ink supplying portion 9, and a control portion 11 as shown in FIG. 1. In order to easily understand, an X-axis, a Y-axis, and a Z-axis which are mutually orthogonal, are shown in FIG. 1. As to FIG. 1 shown below, the X-axis, the Y-axis, and the Z-axis which are mutually orthogonal are also illustrated, as necessary. Moreover, the X-axis, the Y-axis, and the Z-axis in FIG. 1 respectively correspond to the X-axis, the Y-axis, and the Z-axis in other figures. Meanwhile, in each X-axis, Y-axis, and Z-axis, the direction of an arrow indicates a + (positive) direction and the direction opposite to the direction of the arrow indicates a − (negative) direction.

The transporting device 3 intermittently transports a recording medium P such as a recording paper in the +Y-axis direction in the figure. Therefore, the Y-axis direction is a transporting direction of the recording medium P. The recording portion 5 is provided at a position opposed to the transporting route of the recording medium P transported by the transporting device 3. The recording portion 5 performs recording with ink on the recording medium P transported by the transporting device 3. The moving device 7 makes the recording portion 5 reciprocate along the X-axis. The ink supplying portion 9 supplies ink to the recording portion 5. The control portion 11 controls the driving of each configuration described above.

The transporting device 3 has a driving roller 12A, a driven roller 12B, and a transporting motor 13 shown in FIG. 1. The driving roller 12A and the driven roller 12B are rotatably configured by the outer peripheries are being contact with each other. The transporting motor 13 generates power for rotationally driving the driving roller 12A. The power from the transporting motor 13 is transmitted to the driving roller 12A through a transmission mechanism. Moreover, the recording medium P clamped between the driving roller 12A and the driven roller 12B is intermittently transported in the +Y-axis direction.

The recording portion 5 includes four relay units 15, a carriage 17, and a recording head 19. The relay unit 15 relays ink supplied from the ink supplying portion 9 to the recording head 19. The recording head 19 is opposed to the transporting route of the recording medium P transported by the transporting device 3. The recording head 19 discharges ink as ink droplets and performs recording on the recording medium P. The carriage 17 mounts four relay units 15 and the recording head 19. Meanwhile, the recording head 19 is connected to the control portion 11 through a flexible cable 31. The discharge of ink droplets from the recording head 19 is controlled by the control portion 11.

The moving device 7 includes a timing belt 43, a carriage motor 45, and a guide shaft 47 as shown in FIG. 1. The timing belt 43 is stretched between a pair of pullies 41A and 41B. The pair of pullies 41A and 41B are laid out along the X-axis. Therefore, the timing belt 43 is stretched along the X-axis. The carriage motor 45 generates power for rotationally driving the pulley 41A. The guide shaft 47 extends along the X-axis. Both ends of the guide shaft 47 are supported by a housing (not shown). The guide shaft 47 guides the carriage 17 along the X-axis.

Meanwhile, in the embodiment, a state in which the printer 1 is arranged on a horizontal face defined by the X-axis and the Y-axis is a use state of the printer 1. In the use state of the printer 1, a direction orthogonal to both of the X-axis and the Y-axis is a vertical direction. The direction orthogonal to both of the X-axis and the Y-axis is written as a Z-axis direction. In the use state of the printer 1, the Z-axis direction becomes a vertical direction. Moreover, in the use state of the printer 1, a direction from the recording head 19 toward the recording medium P, that is, a −Z-axis direction is a vertical down direction in FIG. 1.

The carriage 17 is fixed to a part of the timing belt 43. The power is transmitted to the carriage 17 from the carriage motor 45 through the pulley 41A and the timing belt 43. Moreover, the carriage 17 is reciprocatably configured along the X-axis by the transmitted power.

The ink supplying portion 9 has a cartridge 51 which is an example of a liquid storing container, a holder 53, and a pump unit 55 as shown in FIG. 1. Moreover, in the embodiment, the ink supplying portion 9 includes a plurality of (four in the embodiment) cartridges 51. The holder 53 holds four cartridges 51. The four cartridges 51 are detachably configured with respect to the holder 53. Ink is stored in each cartridge 51. The inks which are mutually different kinds are stored in the four cartridges 51. In the embodiment, inks of yellow (Y), magenta (M), cyan (C) and black (K) are respectively stored in different cartridges 51. In the printer 1, when ink in the cartridge 51 is consumed, the cartridge 51 is replaced with a new cartridge 51.

An ink supplying tube 61 is connected to each cartridge 51. The ink supplying tube 61 is connected to the relay unit 15 of the recording portion 5 on the side opposite to the cartridge 51 side. The pump unit 55 pressurizes the inside of the cartridge 51 by sending air into the cartridge 51 attached to the holder 53. Accordingly, the inside of the cartridge 51 is pressurized. Therefore, ink in the cartridge 51 is sent to the relay unit 15 through the ink supplying tube 61. Accordingly, ink in the cartridge 51 is supplied to the recording head 19 through the relay unit 15. Moreover, the ink which is supplied to the recording head 19 is discharged from a nozzle (not shown) turned to the recording medium P side as ink droplets.

In the printer 1 having the configuration described above, the driving of the transporting motor 13 is controlled by the control portion 11 and the transporting device 3 intermittently transports the recording medium P in the Y-axis direction while making the recording medium P be opposed to the recording head 19. At this time, the control portion 11 controls the driving of the carriage motor 45 while the transportation of the recording medium P stops, and controls the driving of the recording head 19 while the carriage 17 reciprocates along the X-axis, to make ink droplets discharge at a predetermined position. That is, when the transportation of the recording medium P stops, ink droplets are discharged from the recording head 19 toward the recording medium P while the recording head 19 intersects along the X-axis on the recording medium P. By such an action, dots are formed on the recording medium P and recording based on recording information such as image data is performed on the recording medium P.

As an aspect of recording, for example, there is an aspect in which recording is performed while the carriage 17 reciprocates in a state in which the transportation of the recording medium P stops. In this case, recording may be performed on both of a forward route and a backward route of the reciprocation of the carriage 17 or recording may be performed on only any one of a forward route and a backward route. In addition, the number of the reciprocation of the carriage 17 when recording is performed may be not only once but also twice or the number over twice. Recording which is performed in a period from a state in which the transportation of the recording medium P stops until the next transportation of the recording medium P is referred to as one line of recording. The aspect of recording described above is an aspect in which one line of recording is performed while the carriage 17 reciprocates. Moreover, when one line of recording is finished, next one line of recording is started after the recording medium P is intermittently transported. Meanwhile, a case of intermittently transporting the recording medium P between one line of recording and next one line of recording is sometimes referred to as a new line.

As another aspect of recording, for example, various kinds of aspects such as an aspect of starting a new line between the forward route and the backward route of the carriage 17 can be employed. The aspect of starting a new line between the forward route and the backward route of the carriage 17 is an aspect in which a new line is started after one line of recording is performed on the forward route of the carriage 17 and then next one line of recording is performed on the backward route of the carriage 17. In the aspect, since a new line is started between the forward route and the backward route of the carriage 17, the time required for recording is easily reduced.

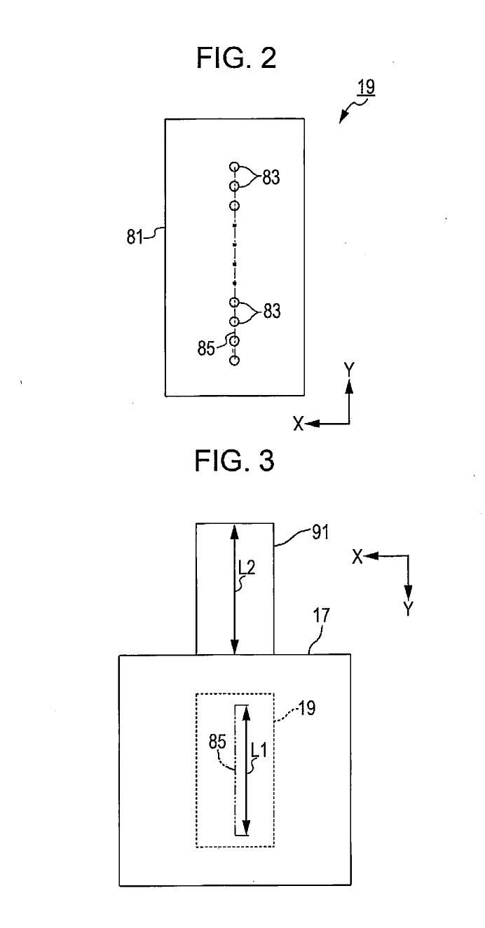

Here, the recording head 19 will be described. The recording head 19 has a nozzle face 81 as shown in FIG. 2 which is a bottom view. A plurality of nozzles 83 for discharging ink droplets are formed on the nozzle face 81. Meanwhile, in FIG. 2, in order to intelligibly show the nozzles 83, the nozzles 83 are exaggerated and the number of nozzles 83 is reduced. In the recording head 19, the plurality of nozzles 83 configures at least one nozzle row 85 which is arrayed along the Y-axis. The number of nozzle rows 85 is not limited to one and two or the number over two can be also employed. In addition, the number of the recording head 19 is not limited to one and two or the number over two can be also employed.

In addition, in the embodiment, a head guard 91 is provided in the carriage 17 as shown in FIG. 3. In FIG. 3, a plane view is shown when the carriage 17 is viewed in plane view in the −Z-axis direction. The carriage 17 and the head guard 91 are integrally configured with each other. Therefore, when the carriage 17 is displaced, the head guard 91 is also displaced by following the displacement of the carriage 17. In an example shown in FIG. 3, the carriage 17 and the head guard 91 are configured as separated bodies from each other and the carriage 17 and the head guard 91 are integrally configured with each other by fixing the head guard 91 to the carriage 17. The configuration of the carriage 17 and the head guard 91 is not limited thereto and, for example, a configuration of being integrally formed with each other can be also employed.

The head guard 91 is positioned on the upper stream side than the recording head 19 in the transporting direction (the Y-axis direction) of the recording medium P. That is, the head guard 91 is positioned in −Y-axis direction more than the recording head 19. The recording head 19 and the head guard 91 are arranged side by side along the Y-axis. Here, in the embodiment, the distance of one transportation of the recording medium P in the recording action is equal to a length L1 or shorter than a length L1 of the nozzle row 85 along the Y-axis. This is because that the length L1 is the maximum length capable of recording along the Y-axis in the recording head 19. Therefore, the maximum transportation distance per one transportation of the recording medium P is equal to the length L1 in the recording action.

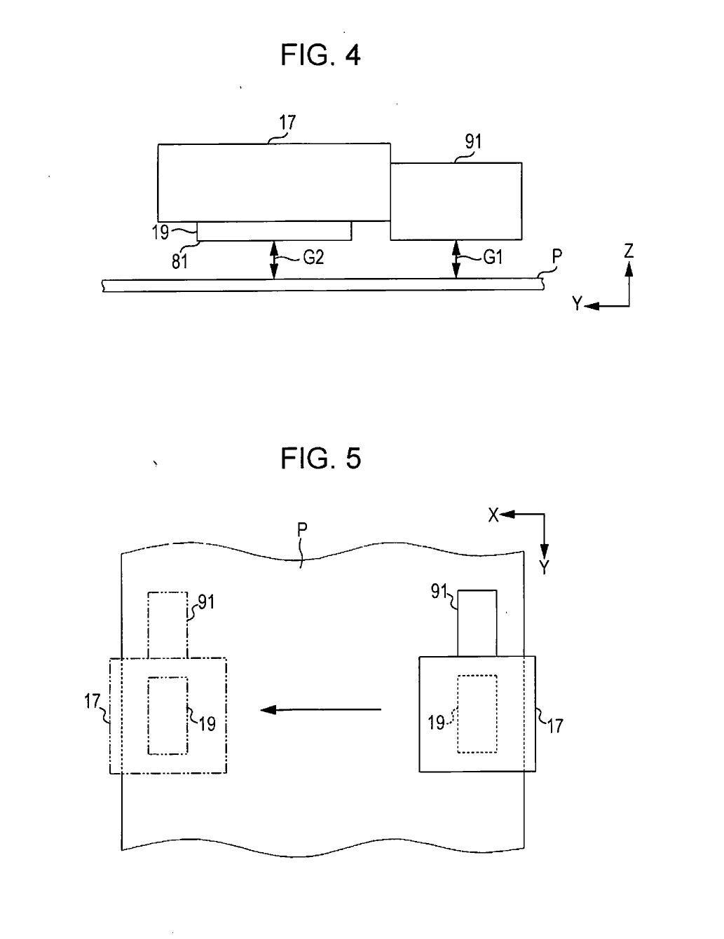

Moreover, a length L2 of the head guard 91 along the Y-axis is set to a length which is equal to the maximum transportation distance of the recording medium P per one transportation or a length which is longer than the maximum transportation distance. Meanwhile, in an example shown in FIG. 3, the length L2 of the head guard 91 along the Y-axis is set to a length which is equal to the maximum transportation distance of the recording medium P per one transportation. The head guard 91 is separated from the recording medium P in the Z-axis direction as shown in FIG. 4 which is a side view illustrating the carriage 17. The head guard 91 and the recording medium P are separated from each other with a gap G1. In addition, the recording head 19 is also separated from the recording medium P in the Z-axis direction. The recording head 19 and the recording medium P are separated from each other with a gap G2.

The gap G1 is set to be equal to the gap G2 or be narrower than the gap G2. According to this setting, for example, in a case where a foreign substance having a size enough to come into contact with the recording head 19 adheres to the recording medium P, it is possible to wipe the foreign substance by the head guard 91 before the foreign substance reaches the recording head 19. Accordingly, it is possible to protect the recording head 19 from the contact with the foreign substance or the like. As a result, it is possible to protect the recording head 19 from damage. In addition, it is also possible to remove dust such as fluff which is an example of the foreign substance by the head guard 91. While fluff is not the foreign substance enough to damage the recording head 19, the recording quality easily deteriorates when ink droplets discharged from the recording head 19 are impacted on fluff. Since it is possible to wipe and remove fluff and adsorb fluff by the head guard 91, the deterioration of the recording quality is easily suppressed.

Meanwhile, in the embodiment, the gap G1 is narrower than the gap G2. Accordingly, it is easy to avoid a case in which the foreign substance which is not as big as the gap G2, that is, the foreign substance being not big enough to come into contact with the recording head 19, enters between the recording head 19 and the recording medium P. As a result, it is easy to avoid the deterioration of the recording quality due to the foreign substance. In addition, it is also possible to easily further remove dust such as fluff which is an example of the foreign substance by the head guard 91. The narrower the gap G1 between the recording medium P and the head guard 91 is, the easier fluff is wiped and removed and fluff is adsorbed, and thus it is easy to further suppress the deterioration of the recording quality. Meanwhile, as a material of the head guard 91, various kinds of materials such as a metal or a resin can be employed. As a material of the head guard 91, it is preferable to be a resin material which is easily charged from the viewpoint of adsorbing fluff.

As described above, in the recording action, the carriage 17 is displaced along the X-axis on the recording medium P in which the recording action is stopped as shown in FIG. 5. In one line of recording, while the carriage 17 is displaced along the X-axis, ink droplets are discharged from the recording head 19 toward the recording medium P. At this time, the head guard 91 is displaced along the X-axis on the recording medium P by following the displacement of the carriage 17 on the upper stream side (the −Y-axis direction side) than the recording head 19. That is, while ink droplets are discharged from the recording head 19 toward the recording medium P on the forward route or the backward route among the reciprocation of the carriage 17, the head guard 91 and the recording medium P are intersected on the upper stream side than the recording head 19. That is, the line on the upper stream side than a line in which recording is performed is intersected with the head guard 91.

Therefore, while recording is executed on the recording medium P by the recording head 19 on the forward route or the backward route among the reciprocation of the carriage 17, it is possible to remove the foreign substance on the recording medium P by the head guard 91 on the upper stream side than the recording head 19. That is, when one line of recording is performed by the recording head 19, it is possible to remove the foreign substance of a next line on the upstream side of the line by the head guard 91. Meanwhile, in Embodiment 1, the direction along the X-axis corresponds to the intersecting direction and the head guard 91 respectively corresponds to the fluff collecting portion and the first part.

### Embodiment 2

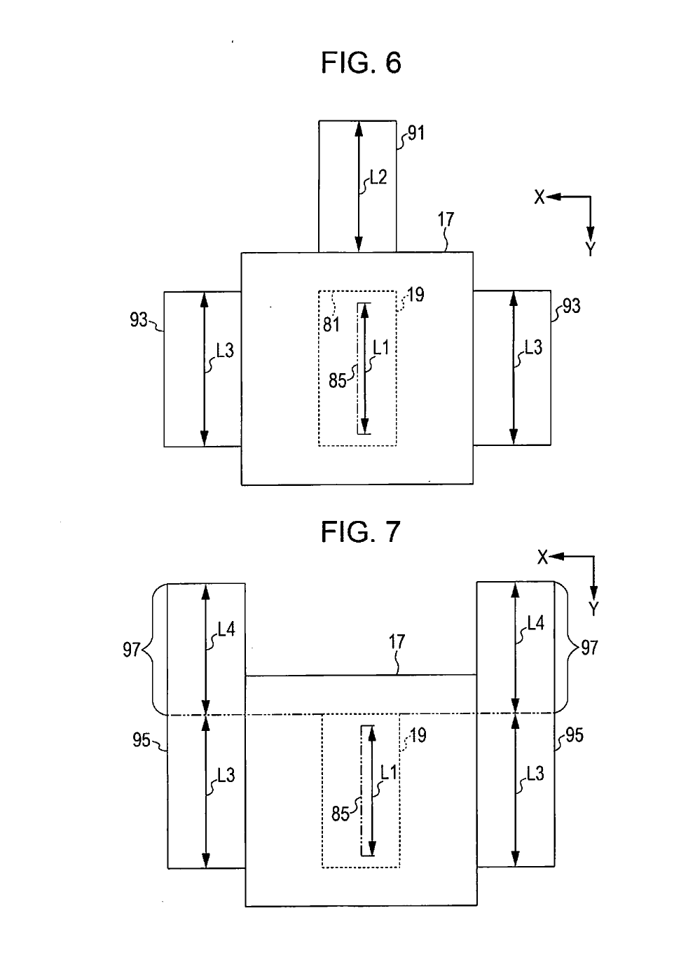

The carriage 17 in Embodiment 2 has a head guard 93 as shown in FIG. 6. Embodiment 2 has the same configuration as that of Embodiment 1 except this point. Therefore, in Embodiment 2, as to the same configuration as that of Embodiment 1, the same signs as those of Embodiment 1 are written and a detailed description will be omitted. In the embodiment, two head guards 93 are provided. The two head guards 93 are arranged side by side along the X-axis. The recording head 19 is positioned between the two head guards 93 arranged side by side along the X-axis.

It is preferable that a length L3 of the two head guards 93 along the Y-axis is equal to the length L1 of the nozzle row 85 along the Y-axis or is longer than the length L1. Accordingly, it is easy to protect the plurality of nozzles 83 configuring the nozzle row 85 and to suppress the deterioration of the recording quality. Furthermore, it is preferable that the length L3 of the two head guards 93 along the Y-axis is equal to a length of the nozzle face 81 along the Y-axis or is longer than a length thereof. Accordingly, it is easy to protect the nozzle face 81 and to suppress the deterioration of the recording quality. In Embodiment 2, the length L3 is set to be equal to the length of the nozzle face 81 along the Y-axis.

Meanwhile, the gap between the two head guards 93 and the recording medium P is set to be equal to the gap G2 or to be narrower than the gap G2. In Embodiment 2, the same effect as that of Embodiment 1 is also obtained. Furthermore, in Embodiment 2, since the two head guards 93 are provided, it is easy to further protect the recording head 19 and to further suppress the deterioration of the recording quality, compared to Embodiment 1. Meanwhile, in Embodiment 2, the direction along the X-axis corresponds to the intersecting direction, the head guard 91 respectively corresponds to the fluff collecting portion and the first part, and the head guard 93 corresponds to the fluff collecting portion.

### Embodiment 3

The carriage 17 in Embodiment 3 has a head guard 95 as shown in FIG. 7. In addition, in the carriage 17 in Embodiment 3, the head guard 91 (FIG. 3) in Embodiment 1 is omitted. Embodiment 3 has the same configuration as that of Embodiment 1 except this point. Therefore, in Embodiment 3, as to the same configuration as that of Embodiment 1, the same signs as those of Embodiment 1 are written and a detailed description will be omitted.

In the embodiment, two head guards 95 are provided. The two head guards 95 are arranged side by side along the X-axis. The recording head 19 is positioned between the two head guards 95 arranged side by side along the X-axis. In addition, when the two head guards 95 are respectively viewed in the X-axis direction, the two head guards 95 extend over a region overlapping with the recording head 19 from the upper stream side than the recording head 19 (the −Y-axis direction side). In the two head guards 95, a part positioned on the upper stream side than the recording head 19 is referred to as a first part 97. A length L4 of the first part 97 along the Y-axis is set to a length which is equal to the maximum transportation distance of the recording medium P per one transportation or a length which is longer than the maximum transportation distance in the same manner as Embodiment 1. In the two head guards 95, a length of a part positioned at the lower stream side than the recording head 19 is set to be the length L3 in the same manner as Embodiment 2.

In addition, the gap between the two head guards 95 and the recording medium P is set to be equal to the gap G2 or to be narrower than the gap G2. In Embodiment 3, the same effect as that of Embodiment 1 and Embodiment 2 is also obtained. Furthermore, in Embodiment 3, since it is possible to omit the head guard 91, it is possible to reduce the cost required for the printer 1, compared to Embodiment 2. Meanwhile, in Embodiment 3, the direction along the X-axis corresponds to the intersecting direction and the head guard 95 corresponds to the fluff collecting portion.

In Embodiment 1 to Embodiment 3, while the recording medium P in the printer 1 is exemplified as the recording paper P of a cutform, the form of the recording medium P is not limited thereto. As a form of the recording medium P, for example, a form of the recording medium P wound in a rolled shape can be also employed. In the printer 1 of a form in which the recording medium P is transported while unwinding the recording medium P wound in a rolled shape from a roll and recording is performed on the unwound recording medium P, the same effect is also obtained.

The entire disclosure of Japanese Patent Application No.: 2014-152637, filed Jul. 28, 2014 is expressly incorporated by reference herein.

What is claimed is:

1. A recording apparatus comprising:
a transporting portion for intermittently transporting a recording medium;
a recording head which is opposed to a transporting route of the recording medium transported by the transporting portion and in which recording is performed on the recording medium in a state separated from the recording medium; and
a fluff collecting portion which is provided separated from the recording medium on the recording head side of the transporting route and includes a first part positioned on an upper stream side than the recording head in a transporting direction of the recording medium transported by the transporting portion,
wherein a length of the first part in the transporting direction is equal to a transportation distance of the recording medium intermittently transported by the transporting portion or is longer than the transportation distance.

2. The recording apparatus according to claim 1,
wherein a length in the transporting direction of the first part is equal to a recordable length along the transporting direction in the recording head or is longer than the recordable length.

3. The recording apparatus according to claim 2, further comprising:
a carriage for holding the recording head; and
a carriage transporting portion for reciprocatably transporting the carriage along an intersecting direction which is a direction intersecting with the transporting direction,
wherein the fluff collecting portion is provided in the carriage,
wherein a plurality of nozzles capable of ejecting ink are formed in a region facing the transporting route in the recording head,
wherein the plurality of nozzles configure a nozzle row which is arrayed in a direction intersecting with the intersecting direction, and
wherein the recordable length is a length of the nozzle row along the transporting direction.

4. The recording apparatus according to claim 3,
wherein the fluff collecting portion is provided on the intersecting direction side of the carriage and extends over a region overlapping with the recording head from an upper stream side in the transporting direction than the recording head when being viewed from the intersecting direction.

5. The recording apparatus according to claim 1,
wherein a gap amount between the fluff collecting portion and the recording medium is narrower than a gap amount between the recording head and the recording medium.
